(19) United States
(12) Patent Application Publication
(10) Pub. No.: US 2026/0061510 A1
(43) Pub. Date: Mar. 5, 2026

(54) Stud Welding Method for Fastening Loop for Wheeled Armored Vehicles

(71) Applicant: Defense Agency for Technology and Quality, Jinju-si (KR)

(72) Inventors: Yun Gon Kim, Changwon-si (KR); Yun Ho Jung, Gimhae-si (KR); Gum Bin Yu, Changwon-si (KR); Sung Mun Kim, Siheung-si (KR)

(21) Appl. No.: 18/783,944

(22) Filed: Jul. 25, 2024

(30) Foreign Application Priority Data
May 20, 2024 (KR) 10-2024-0065041

(51) Int. Cl. B23K 9/20; B23K 101/00

(52) U.S. Cl. CPC B23K 9/202; B23K 2101/006

(57) ABSTRACT

The present disclosure relates to a fastening loop welding method according to the present disclosure, which is a stud welding method for a fastening loop, including mounting a fastening loop chuck on a stud gun; inserting the fastening loop into the fastening loop chuck; setting a welding condition for the stud gun; and welding the fastening loop to a welding target.

### CROSS-REFERENCE TO RELATED APPLICATION

This application claims priority to Korean Patent Application No. 10-2024-0065041, filed May 20, 2024, the disclosure of which is hereby incorporated by reference in its entirety.

### BACKGROUND

### Technical Field

The following disclosure relates to a stud welding method for a fastening loop for wheeled armored vehicles.

### Technical Considerations

Wheeled armored vehicles operate using wheels like regular vehicles.

The wheeled armored vehicles apply armor plates to vehicle body structures to ensure rapid mobility and excellent protection performance.

The armor plate that constitutes the vehicle body structure has a harness cable installed on its inside. The harness cable is installed in a loop joined to the armor plate.

The loop functions to prevent sagging and secure the cable by fastening cable ties when installing the harness cable.

The loop is joined to two types of armor plates of different hardness by welding, and the loop should be joined to the armor plate with appropriate strength.

Conventionally, the loop was joined to the armor plate using a gas tungsten arc welding (GTAW) welding method. The GTAW welding had the problem of excessive welding volume and deterioration in the protective performance and mechanical strength of a heat-affected zone of the armor plate due to thermal strain.

### SUMMARY

A non-limiting embodiment of the present disclosure is directed to providing a stud welding method for a fastening loop for wheeled armored vehicles capable of preventing deterioration in mechanical strength, and at the same time, increasing productivity when joining the loop to an armor plate of the wheeled armored vehicles.

In one general non-limiting aspect, a stud welding method for a fastening loop includes: mounting a fastening loop chuck on a stud gun; inserting the fastening loop into the fastening loop chuck; setting a welding condition for the stud gun; and welding the fastening loop to a welding target.

The welding target may be an armor plate.

The armor plate may be used for a wheeled armored vehicle.

The fastening loop may have a rectangular loop shape with a welded part protruding from a lower end thereof.

In the welding, the fastening loop may weld the welded part to the welding target.

The welded part may be welded to the welding target to form a single welded area.

The fastening loop chuck may form a mounting part for mounting on the stud gun at one end thereof and an insertion part for inserting the fastening loop at the other end thereof, and in the mounting, the mounting part may be mounted on the stud gun, and in the inserting, the fastening loop may be inserted into the insertion part.

In the setting, a current intensity may be 550 A and a current application time may be 0.035 sec.

### BRIEF DESCRIPTION OF THE DRAWINGS

FIG. 1 is a block diagram of a fastening loop welding method according to a non-limiting embodiment according to the principles of the present disclosure;

FIG. 2 is a perspective view of a fastening loop used in the fastening loop welding method according to a non-limiting embodiment according to the principles of the present disclosure;

FIG. 3 is a perspective view of a fastening loop chuck used in the fastening loop welding method according to a non-limiting embodiment according to the principles of the present disclosure;

FIG. 4 is a diagram illustrating a fastening loop chuck mounted on a stud gun in the fastening loop welding method according to a non-limiting embodiment according to the principles of the present disclosure;

FIG. 5 is a diagram illustrating a wheeled armored vehicle to which the fastening loop welding method according to a non-limiting embodiment is applied according to the principles of the present disclosure;

FIG. 6 is a diagram illustrating a fastening loop welded to a welding target in the fastening loop welding method according to a non-limiting embodiment according to the principles of the present disclosure;

FIG. 7 is a diagram illustrating the results of a bending test performed on one to which the fastening loop welding method according to a non-limiting embodiment is applied according to the principles of the present disclosure; and

FIGS. 8 and 9 are views showing a conventional loop and a welded area of the conventional loop.

### DETAILED DESCRIPTION

Hereinafter, the present disclosure will be described in detail with reference to the accompanying drawings. However, this is only an example and the present disclosure is not limited to the specific embodiments described by way of example.

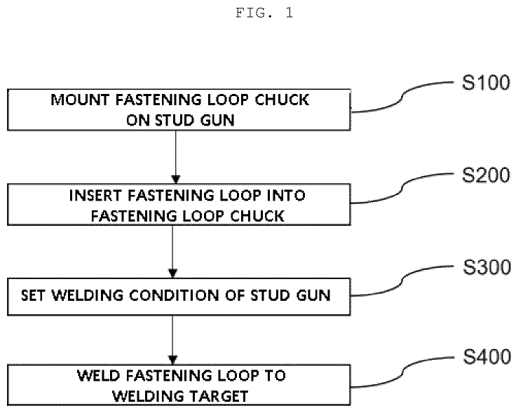

Referring to FIG. 1, a fastening loop welding method according to a non-limiting embodiment of the present disclosure may include mounting a fastening loop chuck 20 on a stud gun 30 (S100); inserting the fastening loop 10 into the fastening loop chuck 20 (S200); setting a welding condition for the stud gun 30 (S300); and welding the fastening loop 10 to a welding target 40 (S400).

The fastening loop welding method according to a non-limiting embodiment of the present disclosure is a stud welding method for the fastening loop 10.

The fastening loop 10 is installed on an armor plate 41.

The armor plate 41 constitutes a vehicle body structure of a wheeled armored vehicle 50. A harness cable is installed on the inside of the armor plate 41. The harness cable is installed in a fastening loop joined to the armor plate.

The fastening loop 10 is installed on the armor plate 41 by welding to install the harness cable on the armor plate 41. The fastening loop welding method according to a non-limiting embodiment of the present disclosure may use the stud welding when installing the fastening loop 10 on the armor plate 41.

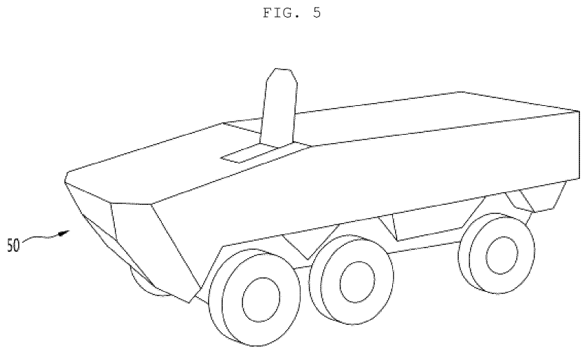

As described above, the welding target 40 to which the fastening loop 10 is welded may be the armor plate 41. The armor plate 41 may be used for the wheeled armored vehicle 50 illustrated in FIG. 5.

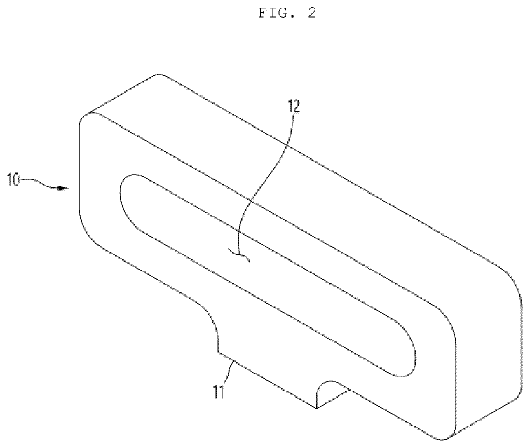

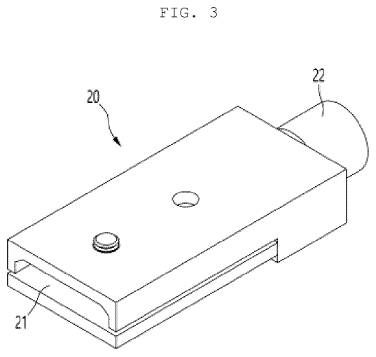

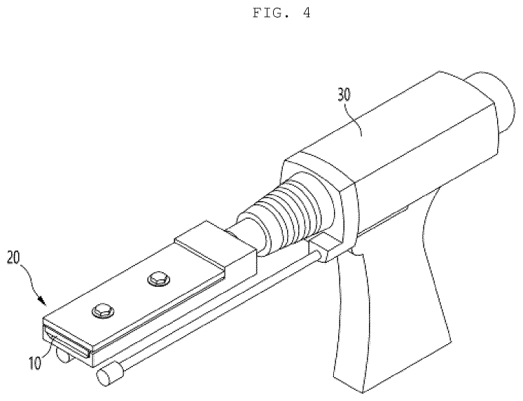

Referring to FIGS. 2 and 3, the fastening loop 10 may be formed in a rectangular loop shape with the welded part 11 protruding from a lower end thereof. The welded part 11 may be formed in the form of a protrusion from the lower end of the fastening loop 10. Since the fastening loop 10 has a loop shape, a central portion thereof may form a penetrating part 12 in a rectangular shape.

Referring to FIG. 2, the fastening loop 10 may have a rounded outer shape. In addition, the penetrating part 12 may also have a rounded shape rather than an angled shape. That is, a corner portion may have a rounded shape. This removes sharp portions from the fastening loop 10, thereby preventing damage to a cable when the cable is installed in the fastening loop 10.

In the mounting step S100, the fastening loop chuck 20 may be mounted on the stud gun 30.

Since the stud gun 30 is a device disclosed as a device for welding objects by the stud welding, detailed description thereof will be omitted.

The fastening loop chuck 20 is a chuck dedicated to the fastening loop 10 for fixing the fastening loop 10 for welding the fastening loop 10 to the welding target 40 by the stud gun 30.

The fastening loop chuck 20 may form a mounting part 22 for mounting on the stud gun 30 at one end thereof and an insertion part 21 for inserting the fastening loop 10 at the other end thereof.

The fastening loop 10 may be inserted into the fastening loop chuck 20 so that the welded part 11 of the fastening loop 10, which is above the welded part welded to the welding target 40, faces downward.

In the inserting step (S200) as described above, the fastening loop 10 is inserted into the insertion part 21 of the fastening loop chuck 20.

In the setting step (S300), the welding conditions of the stud gun 30 to weld the fastening loop 10 to the welding target 40 are set. In this case, the welding conditions are preferably that a current intensity is 550 A and a current application time is 0.035 sec.

In the welding step (S400), the fastening loop 10 may be welded to the welding target 40.

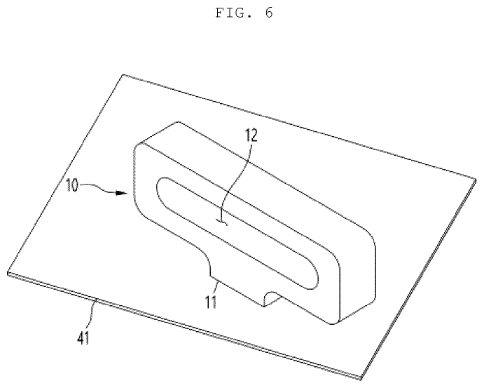

Referring to FIGS. 2 and 6 together, the fastening loop 10 may weld the welded part 11 to the welding target 40. In this case, the welded part 11 may be welded to the welding target to form a single welded area.

Since the single welded part 11 is welded to the welding target 40, multiple welds are not necessary and the single welded area may be formed through one welding.

Hereinafter, the test results of welding the fastening loop 10 using the fastening loop welding method according to the present disclosure will be described.

Verification was performed in accordance with TACOM Drawing 12479550 Chapter 7 STUD Welding, which is the authinance welding standard for wheeled armored vehicles. According to this, the STUD welding method is a welding method applicable to armored steel and general steel.

The test was a tensile test, a bending test, and a macro/hardness test, and the results are shown in the table below. The welding target is an armor plate, and armor steel that meets welding standards was used.

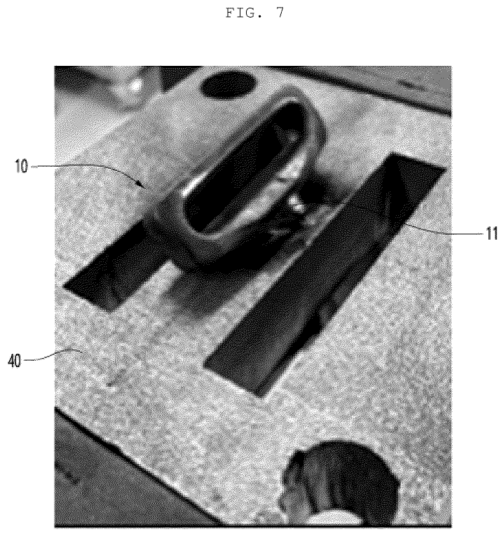

Here, the conventional welding method used a gas tungsten arc welding (GATW) welding method. The conventional loop was used in the conventional welding method. Here, the shape of the conventional loop is the same as illustrated in FIG. 7.

In the table below, the conventional welding method is denoted by the GTAW, and the welding method according to the present disclosure is denoted as STUD. The welding target is an armor plate, and armor steel that meets welding standards was used, and the welding target was classified by number according to type. Multiple samples were classified alphabetically.

Table 1 shows the results of the tensile test.

As can be seen in Table 1, the conventional loop has an average tensile load of 4.42 kN, and the fastening loop applying the fastening loop welding method according to the present disclosure (hereinafter referred to as fastening loop) has an average tensile load of 5.29 kN, which may confirm that equivalent or better performance is secured when the welded area breaks without falling off.

TABLE 1

| | Welding | | Welding | | Welding | | Welding | |
|---|---|---|---|---|---|---|---|---|
| | Target | | Target | | Target | | Target | |
| | 1_STUD | | 2_STUD | | 1_GTAW | | 1_GTAW | |
| Thickness | 6.35 | 9.525 | 6.35 | 11 | 6.35 | 9.525 | 6.35 | 11 |
| Max. | 5.34 | 5.22 | 5.25 | 5.36 | 4.28 | 4.48 | 4.47 | 4.46 |
| load(kN) | | | | | | | | |
| Avg. | | | | | | | | |

The results of the bending test may be seen in FIG. 7.

Referring to FIG. 7, it can be seen that the welded part 11 does not fall off the welding target 40 even at a bending strength of 30° or more, which are the required conditions.

Table 2 shows the results of the macro test.

As can be seen in Table 2, it can be seen that the penetration depth of the fastening loop welding was reduced by about 3 times compared to the conventional loop welding, and the heat-affected zone depth was reduced by about 6 times.

It can be seen that, in the case of the conventional loop welding, the hardness changes up to a penetration depth of 1.669 mm, but in the fastening loop welding, the hardness changes only up to a penetration depth of 0.441 mm.

TABLE 2

Depth (mm)

| | | Heat-affected |
|---|---|---|
| Division | Penetration area | zone |
| GTAW-welding | 1.348 | 4.024 |
| target 1-A | | |
| GTAW-welding | 1.669 | 3.804 |
| target 1-B | | |
| GTAW-welding | 1.228 | 3.073 |
| target 2-C | | |
| GTAW-welding | 1.171 | 3.703 |
| target 2-D | | |
| STUD-welding | 0.422 | 0.661 |
| target 1-E | | |
| STUD-welding | 0.39 | 0.605 |
| target 1-F | | |
| STUD-welding | 0.441 | 0.674 |
| target 2-G | | |
| STUD-welding | 0.409 | 0.63 |
| target 2-H | | |

Table 3 shows the results of the hardness test.

In the hardness test in Table 3, it can be seen that the hardness of 5 points was measured at intervals of 0.5 mm in the depth direction, and the hardness changes in the penetration area. (Here, the hardness indicates the degree of hardness and the amount of resistance of the material that appears when one object undergoes local plastic deformation by another object. Here, the hardness used indicates Vickers hardness (HV).)

TABLE 3

| | Test Result | | | | |
|---|---|---|---|---|---|
| Division | 1 | 2 | 3 | 4 | 5 |
| GTAW-welding | 308.582 | 318.887 | 431.655 | 438.166 | 444.826 |
| target 1-A | | | | | |
| GTAW-welding | 395 | 424.24 | 426.339 | 438.166 | 451.639 |
| target 1-B | | | | | |
| GTAW-welding | 246.314 | 248.878 | 432.192 | 510.873 | 532.981 |
| target 2-C | | | | | |
| GTAW-welding | 305.046 | 304.092 | 544.958 | 541.926 | 591.077 |
| target 2-D | | | | | |
| STUD-welding | 482.414 | 458.023 | 463.944 | 445.388 | 454.524 |
| target 1-E | | | | | |
| STUD-welding | 420.604 | 459.198 | 462.751 | 453.367 | 443.706 |
| target 1-F | | | | | |
| STUD-welding | 403.107 | 521.395 | 532.246 | 534.457 | 538.172 |
| target 2-G | | | | | |
| STUD-welding | 163.17 | 589.361 | 504.711 | 543.439 | 536.681 |
| target 2-H | | | | | |

Table 4 compares the protection power.

As can be seen in Table 4, when the fastening loop is welded to the armor plate using the welding method according to the present disclosure, it can be confirmed that the protection power increases by 19.3% compared to the conventional welding method. (Here, the thickness of the welding target was based on 6.35T.)

TABLE 4

| | Hardness Reduction | Effective Sheet |
|---|---|---|
| Based on 6.35 T | Depth (mm) | Thickness (mm) |
| GTAW | 1.669 | 4.681(73.72%) |
| STUD | 0.441 | 5.909(93.06%) |

Referring to the tables above, the hardness is directly related to the protection power, and the size of the hardness may be viewed as the protection power. In other words, the higher the hardness, the higher the protection power. Referring to Table 2, in the case of the GTAW welding of the conventional loop, the hardness changes up to a penetration depth of 1.669 mm, but when the welding method according to the present disclosure is applied to the fastening loop, it can be seen that the hardness changes only up to a penetration depth of 0.441 mm. Therefore, it can be seen that the protection power is higher.

As described above, the fastening loop welding method according to the present disclosure shows the improved test results compared to the conventional welding method.

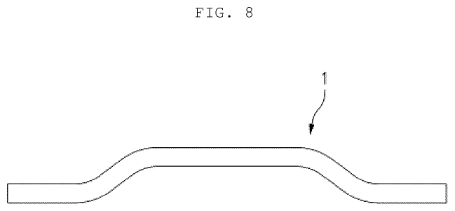

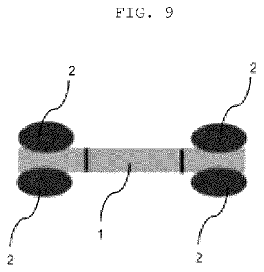

In addition, the conventional loop 1 has a shape as illustrated in FIG. 8. When the conventional loop 1 is welded using the conventional welding method, up to four locations on the welded area 2 may be formed as illustrated in FIG. 9. Therefore, the productivity may decrease and the strength of the welded area may decrease due to the thermal strain.

On the other hand, the fastening loop welding method according to the present disclosure may increase the productivity through the loop with the dedicated shape for joining to the armor plate of the wheeled armored vehicles, and the stud welding method may be applied to reduce the thermal strain and increase the mechanical strength.

According to the present disclosure, it is possible to increase the productivity through the loop having the dedicated shape for joining to the armor plate of the wheeled armored vehicles.

In addition, by applying the stud welding method when welding the loop to the armor plate, it is possible to reduce the thermal strain and increase the mechanical strength.

The embodiments of the present disclosure described above are merely exemplary, and those skilled in the art will appreciate that various modifications and equivalent other embodiments are possible therefrom. It may be understood well that the present disclosure is not limited to only a form mentioned in the above detailed description. Accordingly, an actual technical scope of the present disclosure is to be defined by a technical spirit of the following claims. In addition, it is to be understood that the present disclosure includes all modifications, equivalents, and substitutes that fall in the spirit and scope of the present disclosure defined by the claims.

What is claimed is:

1. A stud welding method for a fastening loop, comprising:
mounting a fastening loop chuck on a stud gun;
inserting the fastening loop into the fastening loop chuck;
setting a welding condition for the stud gun; and
welding the fastening loop to a welding target.

2. The stud welding method of claim 1, wherein the welding target is an armor plate.

3. The stud welding method of claim 2, wherein the armor plate is used for a wheeled armored vehicle.

4. The stud welding method of claim 1, wherein the fastening loop has a rectangular loop shape with a welded part protruding from a lower end thereof.

5. The stud welding method of claim 2, wherein, in the welding, the fastening loop welds the welded part to the welding target.

6. The stud welding method of claim 3, wherein the welded part is welded to the welding target to form a single welded area.

7. The stud welding method of claim 1, wherein the fastening loop chuck forms a mounting part for mounting on the stud gun at one end thereof and an insertion part for inserting the fastening loop at the other end thereof,
in the mounting, the mounting part is mounted on the stud gun, and
in the inserting, the fastening loop is inserted into the insertion part.

8. The stud welding method of claim 1, wherein, in the setting, the welding condition is that a current intensity is 550 A and a current application time is 0.035 sec.
